(19) United States
(12) Patent Application Publication
(10) Pub. No.: US 2007/0243514 A1
(43) Pub. Date: Oct. 18, 2007

(54) EDUCATIONAL BOOK

(76) Inventor: Tyren Scott Thomas, Chicago, IL (US)

Correspondence Address: LAW OFFICE OF MICHAEL A. BLAKE, 112 BROAD STREET, MILFORD, CT, 06460, US

(21) Appl. No.: 11/279,578

(22) Filed: Apr. 13, 2006

(51) Int. Cl. G09B 5/00

(52) U.S. Cl. 434/317

(57) ABSTRACT

A book comprising: a front cover; a back cover in communication with the front cover, a back side located on the back cover; a plurality of pages located between the front cover and the back cover, information located on each of the plurality of pages; and an index located on the back side.

### TECHNICAL FIELD

The field of invention relates to educational books, and specifically relates to educational books that are to be read to others.

### BACKGROUND

Studies have shown that a crucial factor in a child's early development involves being read to on a regular basis. Regularly reading to a child can form a close bond between child and parent, carrying them both to delightful worlds of fantasy and wonder. In addition, being read to is also beneficial to a child's educational development. Reading to children can improve their vocabulary and socialization skills. However, when reading to a child, or anyone for that matter, from a book with illustrations, the child may become distracted from the reading because of the child's interest in seeing the illustration (which because the reader is reading from the book, the illustration is not visible to the child) and begin to lose interest. Thus there is a need for a educational book that may be used to read to children and/or adults, which overcomes this and other disadvantages.

### SUMMARY

The disclosed invention relates to a book comprising: a front cover; a back cover in communication with the front cover, a back side located on the back cover; a plurality of pages located between the front cover and the back cover, information located on each of the plurality of pages; and an index located on the back side.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective front view of the disclosed educational book with the book opened;

FIG. 2 is a perspective rear view of the disclosed educational book with the book closed; and

FIG. 3 is a perspective rear view of the disclosed educational book from FIG. 1, with the book opened.

### DETAILED DESCRIPTION

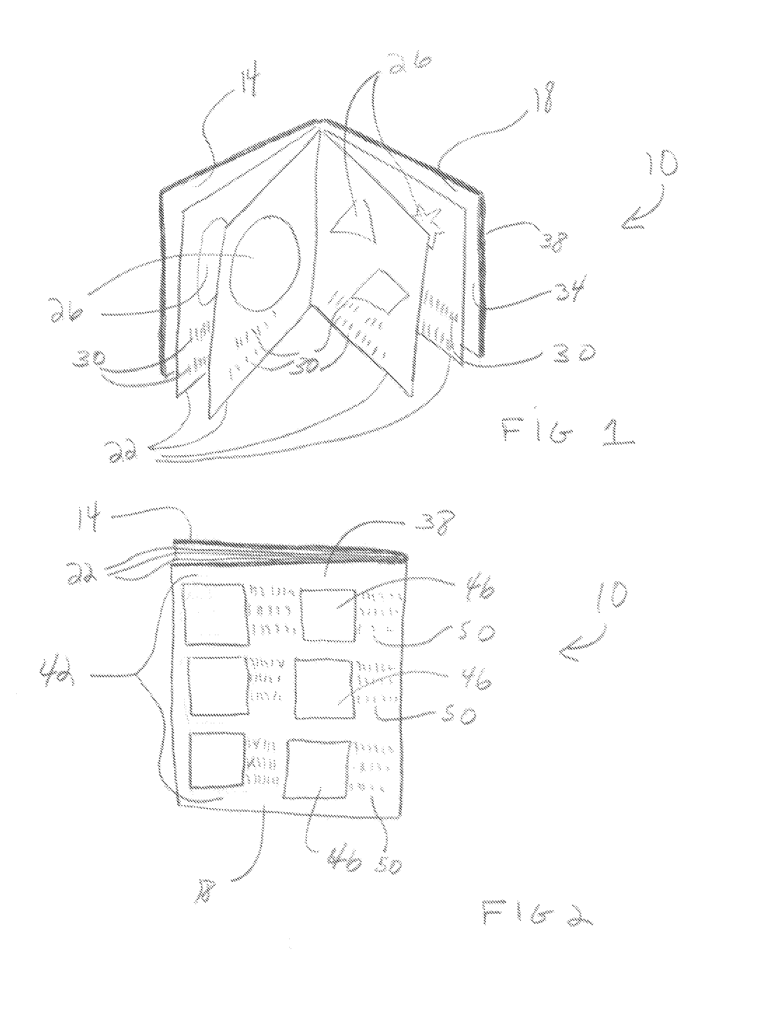

FIG. 1 is a perspective view of one embodiment of the disclosed educational book 10. The book comprises a front cover 14, a back cover 18, and a plurality of pages 22. Each of the pages have information located on them. The information may be graphics 26 such as, but not limited to illustrations, photographs, pop-ups and drawings. The information may also be text 30. Some or all of the pages may only have text 30, and/or may only have graphics 26. The back cover 18 has a front side 34 and a back side 38. The book 10 in FIG. 1 is shown in an opened orientation.

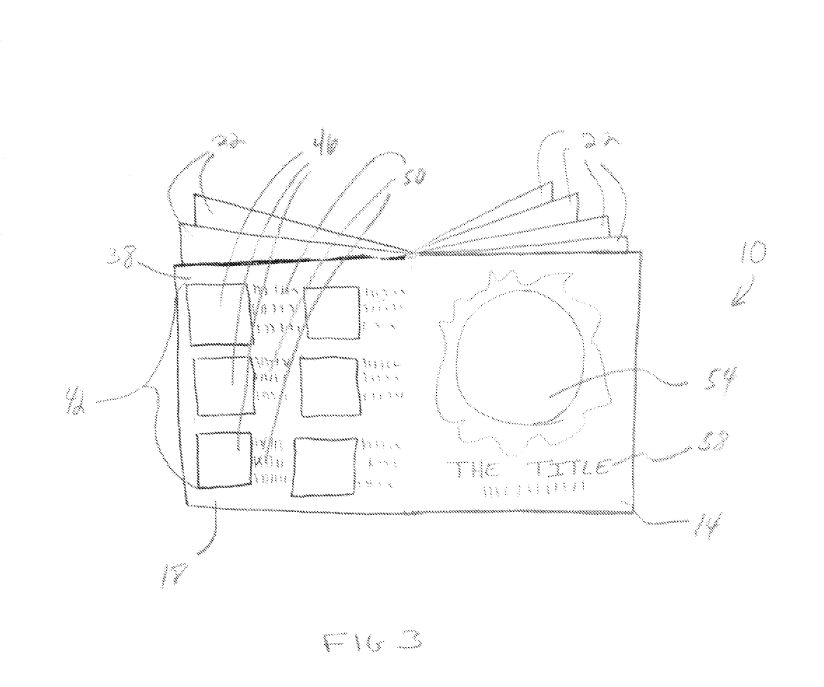

FIG. 2 is a perspective rear view of the educational book 10 from FIG. 1. In this view, the book 10 is shown in a closed orientation. The back side 38 of the back cover 18 has an index 42 of the pages 22. The index 42 comprises a graphics thumbnail 46 of the graphic 26 on each page 22, along with a text thumbnail 50 for the corresponding text 30 for that page 22. In this patent application, a thumbnail means a small version of the information, graphic, or text. Thus, if the book 10 comprises 6 pages, each page with graphics 26 and text 30, then the index will comprise 6 graphics thumbnails 46 along with 6 text thumbnails 50. The text thumbnails 50 and graphic thumbnails 46 will be large enough so that both are easily legible and/or discernable. The index 42 will have a graphic thumbnail 46 and/or text thumbnail 50 for each page 22 in the book. The thumbnails in the index will be sized such that all the pages 22 of the book 10 may be represented in thumbnail fashion on the back side 38 of the back cover 18. In the shown in embodiment, the text thumbnail 50 is shown along side the graphic thumbnail 46. However, in other embodiments, an information thumbnail of the information shown on the page 22 in its entirety may be used in the index 42, where the information in the information thumbnail, such as, but not limited to: graphics 26 and text 30, is shown in the same relative orientation to one another as they are on the page 22. In another embodiment, the pages 22, may have page numbers. The page numbers may be shown on the index 42 near or on the text thumbnail 50 or graphic thumbnail 46.

FIG. 3 is a perspective rear view of the educational book 10 from FIG. 2, wherein the book 10 is shown in an opened configuration. The front cover may have a front cover illustration 54 and book title 58. The book 10 may be used to read to children, adults with learning disabilities, and adults just learning to read. However, instead of a reader reading a page or so from a book, and then turning the book so that the people/person being read to can see the graphic and/or text, the reader can simply read from the index 42 on the back side 38 of the back cover 18, while holding the book so that the people/person being read to can see the pages 22 and see the graphic 26 and text 30 at the same time as the reader reads from the index 42.

The disclosed educational book allows a reader to read to a person or a group of people from the book, while allowing the person or people to see the graphics and text on the page of the book. This may help people to learn to read. Additionally, while keeping the pages facing towards the people being read to, the people being read to are more likely to stay interested in the book being read. Additionally, the people being read to will not be distracted by the reader flipping the book to read from the book, and flipping the book around to show the people the graphics on the page and/or the text on the page.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A book comprising:
a front cover;
a back cover in communication with the front cover,
a back side located on the back cover;
a plurality of pages located between the front cover and the back cover,
information located on each of the plurality of pages; and
an index located on the back side.

2. The book of claim 1, wherein the information comprises graphics, and wherein the index comprises a thumbnail of the graphics for each of the plurality of pages.

3. The book of claim 1, wherein the information comprises text, and wherein the index comprises a thumbnail of the text for each of the plurality of pages.

4. The book of claim 1, wherein the index comprises a thumbnail of the information located on each of the plurality of pages.

5. The book of claim 1, wherein the index comprises:
a plurality of thumbnails; and
wherein the thumbnails are arranged in the same order as the plurality of pages.

6. The book of claim 5, wherein the plurality of thumbnails each have a page number.
